(19) United States
(12) Patent Application Publication
(10) Pub. No.: US 2025/0247817 A1
(43) Pub. Date: Jul. 31, 2025

(54) Optimizing Automated Frequency Coordination for Fixed Path Uses

(71) Applicant: Cisco Technology, Inc., San Jose, CA (US)

(72) Inventors: Roberto Muccifora, Ropraz (CH); Amine Choukir, Ecublens (CH); Domenico Ficara, Essertines-sur-Yverdon (CH); Alessandro Erta, Licciana Nardi (IT); Pascal Thubert, Roquefort-les-Pins (FR); Sachin D. Wakudkar, St-Sulpice (CH); Jerome Henry, Pittsboro, NC (US)

(21) Appl. No.: 18/429,238

(22) Filed: Jan. 31, 2024

(51) Int. Cl. H04W 64/00; H04W 16/14; H04W 84/00

(52) U.S. Cl. CPC H04W 64/003; H04W 16/14; H04W 84/005

(57) ABSTRACT

Devices, systems, methods, and processes for optimizing wireless communications on paths is described herein. Paths may be associated with vehicles which can include one or more mobile access points (APs). When travelling on a constrained path or track, a series of polygons can be configured to project a time-series determination on the upcoming available channels and power levels available. By utilizing the embodiments described herein, mapping along the polygon paths can help to optimize the selected channels based on the current trajectory. The AP can subsequently select channels that fulfill a constrained optimization function or similar problem based on the current network and path conditions. These embodiments can be operated on an automated frequency coordination (AFC) device, or network device that is in communication with the AP and/or AFC. Data may be held as well based on the current network conditions and transmitted based on the determined upcoming conditions.

The present disclosure relates to network device management. More particularly, the present disclosure relates to optimizing automated frequency coordination processes on fixed path locations.

### BACKGROUND

Automated frequency coordination (AFC) in wireless networking refers to the dynamic and intelligent management of radio frequency (RF) spectrum usage to mitigate interference and optimize the overall performance of wireless devices. In environments with numerous wireless devices, such as Wi-Fi networks or wireless communication systems, AFC becomes crucial to ensure efficient spectrum utilization.

AFC systems automatically monitor the radio frequency spectrum, identify available channels, and allocate frequencies to devices based on real-time usage patterns. This process helps prevent interference between devices operating on the same or adjacent frequencies, ultimately improving the reliability and throughput of wireless communications. AFC is particularly vital in crowded urban areas or locations with a high density of wireless devices, where effective spectrum management is essential for maintaining network quality and minimizing signal disruptions. Automated frequency coordination plays a key role in enhancing the overall efficiency and reliability of wireless networks by adapting to dynamic changes in the radio frequency environment.

The Federal Communications Commission (FCC) in the United States has allocated the 6 GHz band for unlicensed use, allowing for the deployment of Wi-Fi 6E technology. Spectrum prediction is a process of forecasting and determining the availability and quality of radio frequency spectrum at specific locations and times. It is particularly relevant in wireless communication systems where devices need to operate on specific frequencies to avoid interference and optimize performance. AFC is often required for a wireless access point (AP) to use spectrum prediction in some sub-bands of the 6 Gigahertz chunk. The prediction helps anticipate the channels that will be available for use by the AP at future locations. This is helpful in scenarios where APs are mobile, such as vehicles with onboard APs on a fixed path, such as a track.

### SUMMARY OF THE DISCLOSURE

Systems and methods for optimizing automated frequency coordination processes on fixed path locations in accordance with embodiments of the disclosure are described herein. In some embodiments, at least one network interface controller is configured to provide access to a network, and a path optimization logic configured to query an access point, wherein the query is associated with a path, receive polygon data, parse the polygon data, and generate a report associated with the parsed polygon data.

In some embodiments, the path optimization logic is further configured to transmit the report.

In some embodiments, the query includes a request for one or more polygons.

In some embodiments, the query includes a request for two or more polygons associated with different altitude levels.

In some embodiments, the path optimization logic is further configured to generate two or more reports and aggregate the two or more reports.

In some embodiments, the path is configured with limited orthogonal movement.

In some embodiments, the path is a track.

In some embodiments, the device is in movement along the track.

In some embodiments, the path optimization logic is further configured to generate a query in response to one or more change events occurring.

In some embodiments, the one or more change events is a change in speed of movement along the track.

In some embodiments, the one or more change events is a variation in the path.

In some embodiments, the polygon data includes at least channel data.

In some embodiments, the polygon data includes at least power usage data.

In some embodiments, at least one network interface controller is configured to provide access to a network, and a path optimization logic configured to receive a query, wherein the query is associated with a path, parse the query for requested data, gather the requested data, package the requested data as polygon data, and transmit the polygon data.

In some embodiments, the query is associated with a plurality of sections of the path. In some embodiments, the plurality of sections of the path form a sub-path.

In some embodiments, parsing the query includes determining a desired level of precision.

In some embodiments, the query includes an estimated time of arrival to a section of the path.

In some embodiments, operating an access point on a path includes receiving automated frequency coordination data, parsing the automated frequency coordination data, determining a channel and bandwidth based on the automated frequency coordination data, and configuring the access point to change to the determined channel and bandwidth.

In some embodiments, the determination includes a constrained optimization decision.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a train on a fixed path in a multi-polygon environment in accordance with various embodiments of the disclosure;

FIG. 2 is a conceptual illustration of determining common channels for a plurality of trains on fixed paths in accordance with various embodiments of the disclosure;

FIG. 3 is a conceptual illustration of a train on a path with multiple altitudes in accordance with various embodiments of the disclosure;

FIG. 4 is a conceptual network diagram of various embodiments that a path optimization logic may operate, in accordance with various embodiments of the disclosure;

FIG. 5 is a flowchart depicting a process for selecting channels based on a location within a path in accordance with various embodiments of the disclosure;

FIG. 6 is a flowchart depicting a process for generating a report based on a location within a path in accordance with various embodiments of the disclosure;

FIG. 7 is a flowchart depicting a process for processing polygon data in accordance with various embodiments of the disclosure;

FIG. 8 is a flowchart depicting a process for operating a sublet system based on a location within a path in accordance with various embodiments of the disclosure;

FIG. 9 is a flowchart depicting a process for operating an access point within a path in accordance with various embodiments of the disclosure;

FIG. 10 is a flowchart depicting a process for holding data when travelling on a path in accordance with various embodiments of the disclosure; and

FIG. 11 is a conceptual block diagram of a device suitable for configuration with a path optimization logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that optimize path-based mobile networking systems. At a high-level, an AP or other wireless local area network controller (WLC), can provide polygon data with path or “track” locations to the AFC devices as a new type of query. Typically, paths can include tracks which are configured with a limited or otherwise restricted movement along an orthogonal axis. The AFC can report tile-by-tile (i.e. polygon-by-polygon) information about channel and power usage on the path. This reported info can be aggregated at different levels as needed. The mobile APs can provide their estimated path with timestamps in order to take advantage of time-bound capabilities, but may be extended to time-series or time window applications as needed. By utilizing these methods and embodiments, frequent channel changes can be avoided. Additionally, worst-case scenarios can be determined such that various additional capabilities or links can be activated per location as needed.

An access point (AP) and an automated frequency coordination (AFC) system are both components of wireless networking, but they serve different functions within the network infrastructure. The relationship between an access point and an AFC system is centered around optimizing the use of radio frequency (RF) spectrum for wireless communication. As those skilled in the art will know, an access point is a device that enables wireless clients (such as laptops, smartphones, or other devices) to connect to a wired network using Wi-Fi or other wireless technologies. The access point acts as a bridge between the wired and wireless networks, facilitating communication between connected devices and providing them with access to the resources on the wired network.

On the other hand, an automated frequency coordination system is responsible for managing and allocating the available radio frequencies to wireless devices, including access points. In environments with multiple access points and other wireless devices, interference can occur if they operate on the same or adjacent frequencies. The AFC system dynamically monitors the RF spectrum, identifies available channels, and allocates frequencies to devices in real-time, optimizing the use of the spectrum and minimizing interference.

The relationship between an access point and an AFC system is cooperative. The AFC system can help the access points by ensuring they operate on non-interfering frequencies, which leads to improved overall network performance. By avoiding interference and optimizing channel selection, the AFC system contributes to the reliability, throughput, and efficiency of the wireless network, benefiting not only the access points but also all the wireless devices connected to the network. This collaboration is especially important in crowded and dynamic RF environments where multiple wireless networks coexist.

Access Points (APs) deployed on paths serve diverse purposes across various industries. In motorsports, vehicles on race paths are often equipped with onboard APs to enable seamless communication between vehicles, pit crews, and race control. This communication encompasses the transmission of telemetry data, video feeds, and real-time performance updates. In the railway sector, APs on paths facilitate communication between trains, trackside infrastructure, and central control systems, ensuring efficient monitoring of train movements and timely maintenance updates. In logistics and warehousing, APs strategically placed along designated paths contribute to tracking the movement of goods, managing inventory, and optimizing material flow within facilities, particularly in automated guided vehicle (AGV) systems. Test paths for autonomous vehicles utilize AP networks to support communication between test vehicles and central control systems, essential for validating autonomous features in a controlled environment. Additionally, in sports and entertainment venues with paths, such as running or cycling paths, deployed APs offer Wi-Fi connectivity for participants, spectators, and event organizers, enhancing the overall experience through features like live streaming and social media updates. The deployment of APs on paths requires careful consideration of factors such as coverage, capacity, and frequency management to optimize wireless communication in these diverse scenarios.

In certain scenarios, where vehicles are on a track and they might have an onboard AP, the request for AFC needs to anticipate the AP path. However, the default location conclusion, based on polygons or low precision works but can be improved, as it has the disadvantage of providing a ‘location’ value much wider than the real position of the AP, with the consequence of artificially reducing the list of potentially usable channels.

Some path-based deployments may utilize a Fluidmesh or other similar technology, which may be part of a product line that specializes in providing solutions for high-speed, long-range, and reliable wireless networking. These networks can often be used in challenging and dynamic environments where traditional wired networks may be impractical or costly to deploy. The technology is particularly known in the art for its ability to deliver robust wireless connectivity for applications such as video surveillance, industrial automation, public safety, and transportation systems. Various embodiments described herein can often utilize a combination of radio frequency (RF) technologies, advanced protocols, and intelligent networking algorithms to create point-to-point or point-to-multipoint wireless links. These links can operate in various frequency bands, including licensed and unlicensed spectrum, to deliver high throughput and low latency connectivity.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

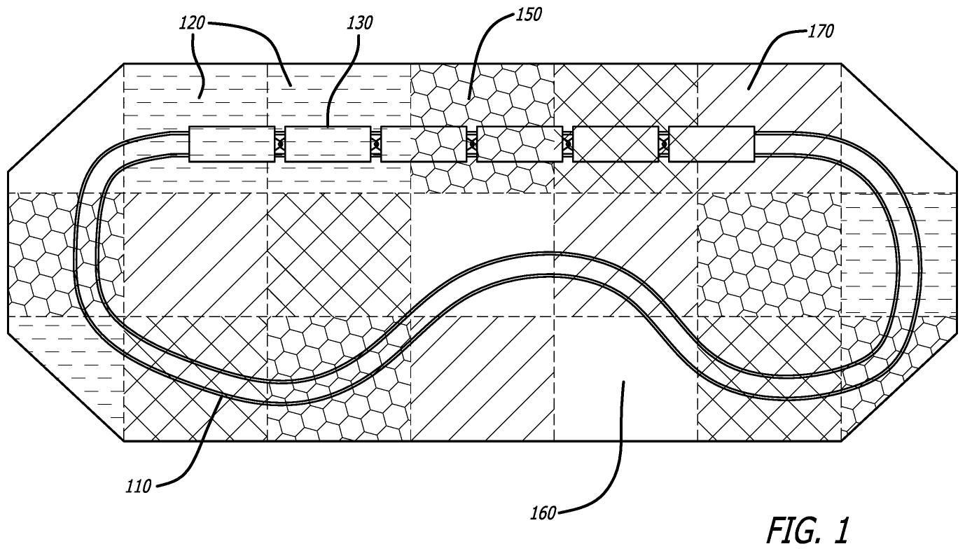

Referring to FIG. 1, a conceptual illustration of a train on a fixed path in a multi-polygon environment in accordance with various embodiments of the disclosure is shown. In many embodiments, a train 130 is operating on a path, such as a track 110 within a given area. The area may be considered to be partitioned into a plurality of areas or “polygons”. While operating the train 130, it may be equipped with a plurality of different APs and AFC devices that are coordinating to provide effective wireless service in areas with different service levels, and available channels.

The integration of AFC and APs on paths, such as for the train 130 can create a sophisticated system to deliver seamless wireless network connections. AFC is utilized for spectrum management by continuously monitoring available frequency bands, dynamically adjusting signals, channels, and bandwidths, and ensuring compliance with regulatory requirements. Meanwhile, strategically positioned APs onboard the train 130 can act as communication hubs, providing comprehensive wireless coverage within the train 130. These APs can support various wireless technologies, including Wi-Fi, enabling passengers to connect their devices to the onboard network. As the train 130 moves along its track 110, AFC devices can facilitate seamless handover between different access points, ensuring uninterrupted connectivity, particularly in scenarios with high-speed movement. Predictive AFC is often employed to anticipate upcoming locations where the train will require wireless connectivity, enhancing stability in challenging signal environments such as tunnels. Passengers can benefit from this system by enjoying continuous internet access, streaming capabilities, and other online activities throughout their journey. Additionally, the onboard wireless network may serve operational and safety applications, enabling communication between train systems, monitoring equipment health, and transmitting real-time data to control centers. In essence, the collaborative operation of AFC and APs can help to optimize spectrum usage, providing reliable connectivity, and enhancing the overall wireless experience for both passengers and operational needs on trains.

However, this optimization must be done when different areas of the track 110 have different available wireless signals for use by the train 130 and APs. As depicted in the embodiment shown in FIG. 1, each type of shading conceptually represents different channel, power, or other network configurations available to the train 130 (and the APs and AFC devices located therein). If the train 130 is moving in a counterclockwise motion, the head is currently in a first polygon area 120 which has a first set of network attributes. Eventually, the train will move into a second polygon area 110 which has a second set of network attributes. Prior to entering the second polygon area 110, the network devices on the train 130 can query the local network devices, as to the current network conditions. This data may be relayed back to the train 130 (and devices therein), which can predict if and when any settings, such as channels and/or broadcast power should be changed prior to entering that polygon.

Indeed, in the embodiment depicted in FIG. 1, the train 130 can move through other areas with different network conditions, such as the third polygon area 160 which does not have any sufficient coverage and thus no network attributes, a forth polygon area 170 that has a third set of network attributes, and eventually to the fifth polygon area 150, which has a fourth set of network attributes. While the embodiment depicted in FIG. 1 is simplified, it is presented to convey the concept that moving along a path can include a change in various network conditions that can be accounted for, predicted, and responded to.

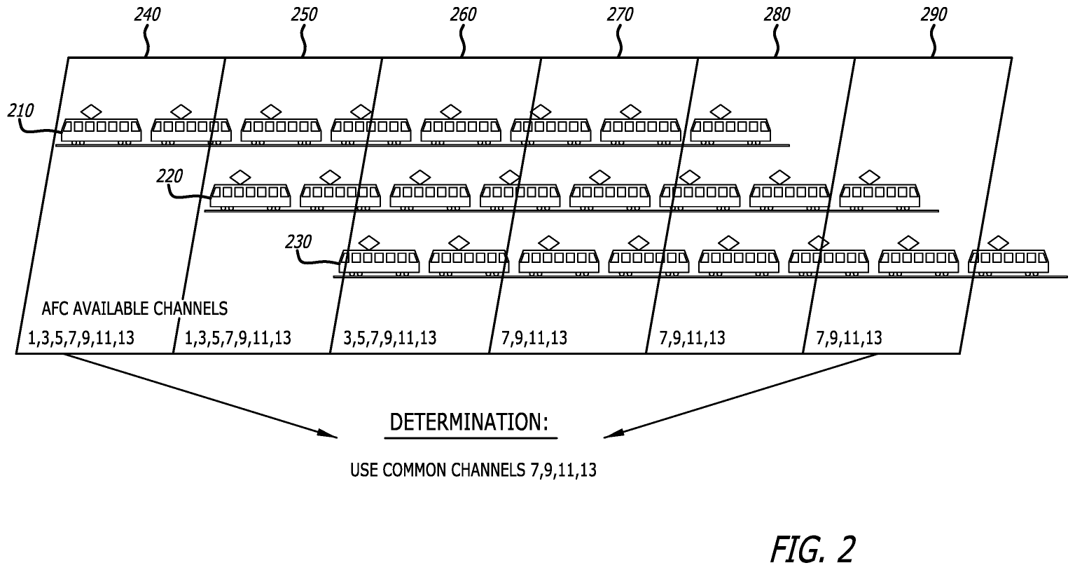

Although a specific embodiment for a train on a fixed path in a multi-polygon environment suitable for carrying out the various steps, processes, methods, and operations described herein is discussed with respect to FIG. 1, any of a variety of systems and/or processes may be utilized in accordance with embodiments of the disclosure. For example, the path may be any fixed area with a limited orthogonal axis for movement. The elements depicted in FIG. 1 may also be interchangeable with other elements of FIGS. 2-11 as required to realize a particularly desired embodiment.

Referring to FIG. 2, a conceptual illustration of determining common channels for a plurality of trains on fixed paths in accordance with various embodiments of the disclosure is shown. In many embodiments, a first train 210, a second train 220, and a third train 230 may be travelling in an area with a plurality of polygons 240-290. Each polygon 240-290 may have a certain number of available channels for use in wireless connections. In the embodiment depicted in FIG. 2, the first polygon 240 and the second polygon 250 each have AFC channels 1, 3, 5, 7, 9, 11, and 13 available. The third polygon 260 has AFC channels 3, 5, 7, 9, 11, and 13 available, while the fourth polygon 270, fifth polygon 280, and sixth polygon 290 have AFC channels 7, 9, 11, and 13 available. Without channel coordination and best common channel determinations, frequent channel changes may be required.

Frequent channel switching in wireless connections, especially in scenarios like vehicles on fixed paths, such as trains, can introduce several undesirable outcomes. Firstly, the process of switching channels incurs a brief interruption in connectivity, leading to potential service disruptions for passengers and operational systems onboard. This interruption is particularly noticeable in applications such as streaming or real-time communication, where a continuous and stable connection is essential. Additionally, frequent channel changes can result in increased latency as devices need time to re-establish connections on the new channels, impacting the responsiveness of the network.

Furthermore, rapid channel switching may contribute to inefficient spectrum utilization, as devices constantly search for and move to what they perceive as a less congested channel. This can lead to unnecessary contention for available channels and degrade overall network performance. Therefore, maintaining a stable channel, with controlled and well-timed handovers, when necessary, is crucial to ensure a reliable and uninterrupted wireless experience on trains and similar environments. Therefore, determining a common channel range can aide in the overall network performance.

In the embodiment depicted in FIG. 2, based on the available AFC channels in each polygon, it is determined that common channel set of 7, 9, 11, and 13 will be used to provide the fewest number of channel changes for this segment of track. In many embodiments, this determination can be achieved through the use of a constrained optimization decision. Those skilled in the art will recognize that additional methods may also be available.

Although a specific embodiment for a determining common channels for a plurality of trains on fixed paths suitable for carrying out the various steps, processes, methods, and operations described herein is discussed with respect to FIG. 2, any of a variety of systems and/or processes may be utilized in accordance with embodiments of the disclosure. For example, the number of trains or groups between vehicles or devices on a track or path may vary depending on the specific application or deployment desired. The elements depicted in FIG. 2 may also be interchangeable with other elements of FIGS. 1 and 3-11 as required to realize a particularly desired embodiment.

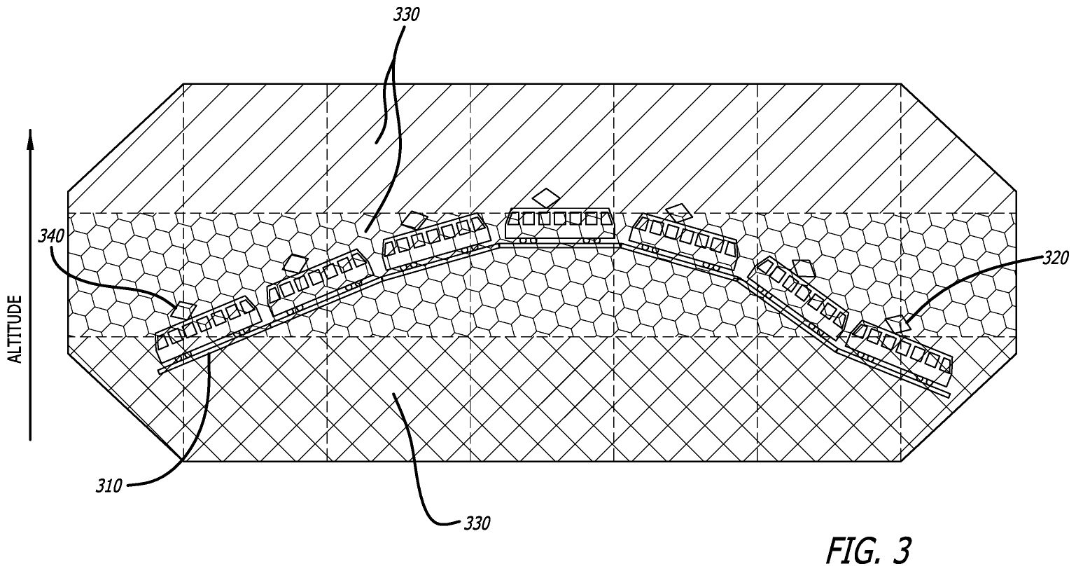

Referring to FIG. 3, a conceptual illustration of a train 310 on a path with multiple altitudes in accordance with various embodiments of the disclosure is shown. Changes in altitude can have notable effects on wireless signals due to various environmental factors. As altitude increases, the density of air decreases, leading to reduced signal absorption and scattering. In turn, this can result in an increase in signal range and coverage, particularly in open spaces with fewer obstacles.

However, altitude changes may also introduce challenges. In mountainous terrain or areas with significant elevation variations, signal obstruction by physical obstacles such as hills or buildings can occur, potentially causing signal degradation or shadow zones. Additionally, changes in altitude may impact the propagation characteristics of wireless signals, influencing factors like signal reflection and refraction. In certain cases, altitude changes can lead to multipath propagation, where signals take multiple paths due to reflections, resulting in signal interference and potential signal fading. Overall, while higher altitudes may offer advantages in terms of increased signal range, the complex interplay of environmental factors requires careful consideration in wireless network planning to ensure optimal signal performance.

In the embodiment depicted in FIG. 3, the train 310 is travelling along a path that has variations in the altitude. The path is conceptually divided into a number of polygons 330. Each row of polygons is associated with a different altitude. Each altitude may have a different level of wireless signals available. Therefore, determinations on AFC coordination can be done based on the current, or upcoming altitude levels. For example, one end of the train is at a first altitude on the second row of polygons. The train then travels into a second altitude in the first row of polygons. However, if the decision was made to change channels based on this change event alone, it would create unnecessary changes as the train subsequently goes back to the original altitude.

It is contemplated that a path optimization logic can be configured to evaluate a plurality of inputs to determine if a new channel or bandwidth should be selected. These inputs may also include looking at upcoming locations within a path, or examining historical data based on prior events, locations, etc. This embodiment is provided to highlight how both a change in altitude can be a change event, so can looking ahead as to what portions, paths, or sub-paths may be coming in the future.

Although a specific embodiment for a train 310 on a path with multiple altitudes suitable for carrying out the various steps, processes, methods, and operations described herein is discussed with respect to FIG. 3, any of a variety of systems and/or processes may be utilized in accordance with embodiments of the disclosure. For example, the path and vehicle described may not be limited to a train, and the altitude changes can be larger or smaller based on the precision needed for the specific wireless network performance. The elements depicted in FIG. 3 may also be interchangeable with other elements of FIGS. 1-2 and 4-11 as required to realize a particularly desired embodiment.

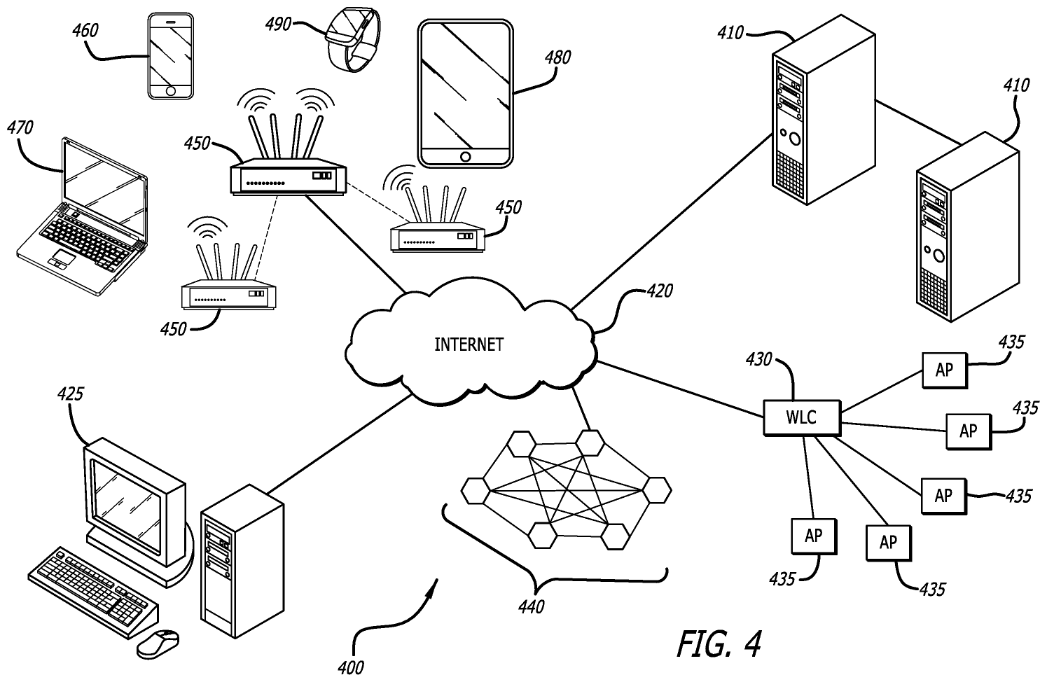

Referring to FIG. 4, a conceptual network diagram of various embodiments that a path optimization logic may operate, in accordance with various embodiments of the disclosure is shown. Those skilled in the art will recognize that the path optimization logic can be comprised of various hardware and/or software deployments and can be configured in a variety of ways. In many embodiments, the path optimization logic can be configured as a standalone device, exist as a logic in another network device, be distributed among various network devices operating in tandem, or remotely operated as part of a cloud-based network management tool. In further embodiments, one or more servers 410 can be configured with or otherwise operate the sustainability logic. In many embodiments, the path optimization logic may operate on one or more servers 410 connected to a communication network 420. The communication network 420 can include wired networks or wireless networks. The path optimization logic can be provided as a cloud-based service that can service remote networks, such as, but not limited to a deployed network 440. In many embodiments, the path optimization logic can be a logic that optimizes the path traversal and management of the network 400.

However, in additional embodiments, the path optimization logic may be operated as a distributed logic across multiple network devices. In the embodiment depicted in FIG. 4, a plurality of network access points (APs) 450 can operate as the path optimization logic in a distributed manner or may have one specific device operate as the path optimization logic for all of the neighboring or sibling APs 450. The APs 450 facilitate Wi-Fi connections for various electronic devices, such as but not limited to mobile computing devices including laptop computers 470, cellular phones 460, portable tablet computers 480 and wearable computing devices 490.

In further embodiments, the path optimization logic may be integrated within another network device. In the embodiment depicted in FIG. 4, a wireless LAN controller (WLC) 430 may have a path optimization logic that the WLC 430 can use to optimize the energy consumption of the various APs 435 that the WLC 430 is connected to, either wired or wirelessly. In still more embodiments, a personal computer 425 may be utilized to access and/or manage various aspects of the sustainability logic, either remotely or within the network itself. In the embodiment depicted in FIG. 4, the personal computer 425 communicates over the communication network 420 and can access the path optimization logic of the servers 410, or the network APs 450, or the WLC 430.

Although a specific embodiment for a conceptual network diagram of various embodiments that a path optimization logic may operate suitable for carrying out the various steps, processes, methods, and operations described herein is discussed with respect to FIG. 4, any of a variety of systems and/or processes may be utilized in accordance with embodiments of the disclosure. For example, the path optimization logic may be within an AFC device, an AP device, or a network device in communication with an AFC or AP device associated with a path. The elements depicted in FIG. 4 may also be interchangeable with other elements of FIGS. 1-3 and 5-11 as required to realize a particularly desired embodiment.

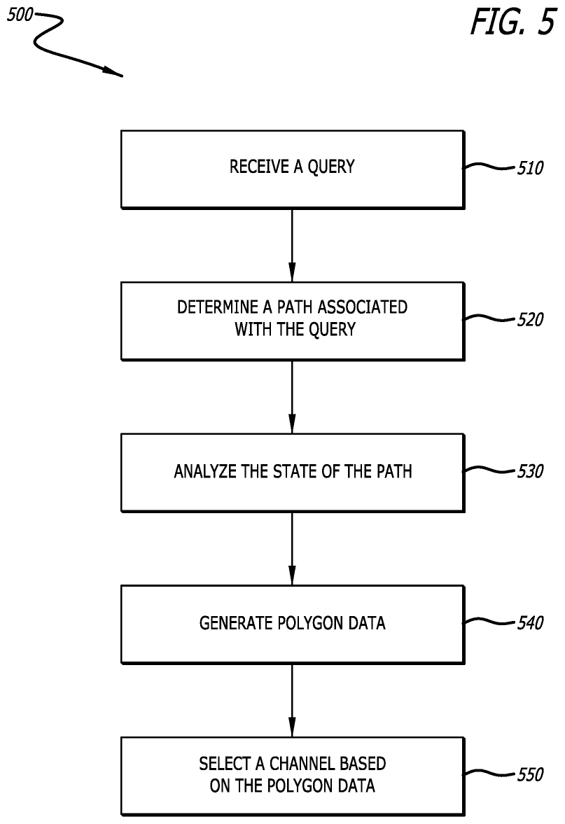

Referring to FIG. 5, a flowchart depicting a process 500 for selecting channels based on a location within a path in accordance with various embodiments of the disclosure is shown. In many embodiments, the process 500 can receive a query (block 510). This query can be generated by an AFC device and sent to a server or other wireless connection device. In some embodiments, this query might be relayed to the intended target.

In a number of embodiments, the process 500 can determine a path associated with the query (block 520). The query may be formatted to request data associated with a location that a vehicle or other device travelling on a path may need in the future. This data may include an estimated time of arrival in certain embodiments, but may also be generalized based on wireless devices that are within broadcast range of the query.

In more embodiments, the process 500 can analyze the state of the path (block 530). In several embodiments, a wireless network device can gather information about the local area associated with the query. This gathering can be by accessing a database, may be generated in response to analyzing various telemetry data, and/or may be determined based sending a request to another network device.

In additional embodiments, the process 500 can generate polygon data (block 540). As described herein, polygons are conceptualized as partitioned areas associated with a path or track. While various embodiments described herein depict fixed shaped areas, it is contemplated that any shape may be utilized, and the shape may not be uniform from polygon to polygon, and may in fact be dynamically generated or change based on various network conditions or attributes (path traversal speed, precision needed, current bandwidth, number of connections, etc.). All data necessary for making various determination, such as channel data, bandwidth data, etc. can be packaged up as polygon data.

In further embodiments, the process 500 can select a channel based on the polygon data (block 550). In certain embodiments, the polygon data is received by an AFC device which can determine one or more channels that should be selected for upcoming use when travelling along the path. Additional configurations may be selected based on the polygon data, including bandwidth.

Although a specific embodiment for selecting channels based on a location within a path suitable for carrying out the various steps, processes, methods, and operations described herein is discussed with respect to FIG. 5, any of a variety of systems and/or processes may be utilized in accordance with embodiments of the disclosure. For example, the various steps described may be carried out by one device or may be split across multiple devices. The elements depicted in FIG. 5 may also be interchangeable with other elements of FIGS. 1-4 and 6-11 as required to realize a particularly desired embodiment.

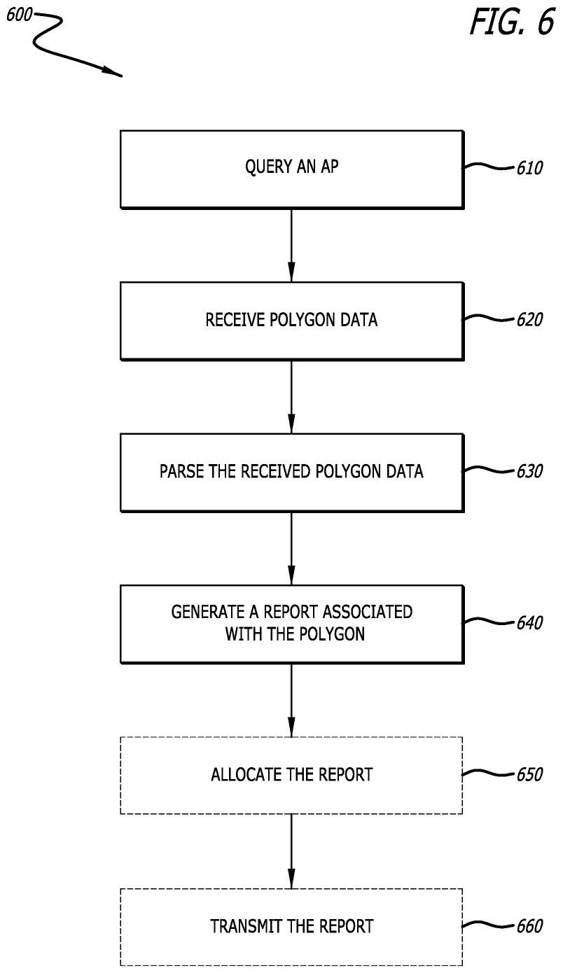

Referring to FIG. 6, a flowchart depicting a process 600 for generating a report based on a location within a path in accordance with various embodiments of the disclosure is shown. AFC devices can continually monitor the radio frequency spectrum, assessing the availability of different frequency bands and identifying potential sources of interference. This information is then often communicated to the AP, which can use it to dynamically adjust its operating frequency or channel. The AFC device and AP maintain an ongoing dialogue to ensure that the AP is operating on the optimal frequency, minimizing interference, and optimizing signal quality.

In many embodiments, the process 600 can query an AP (block 610). The AP can receive this query during normal operation or in response to a change event. The query may be received from a separate device, but may be, in certain embodiments, received from another internal logic within the AP.

In a number of embodiments, the process 600 can receive polygon data (block 620). Often, an AP will request polygon data from a wireless network device nearby the track or an upcoming portion of the track. The polygon data received can be passed along, such as to an AFC device or logic.

In more embodiments, the process 600 can parse the received polygon data (block 630). Parsing the polygon data may include separating the different types of data that are available, such as channel data, bandwidth data, etc. However, in some embodiments, the polygon data may include historical data, or other time-series data that may be utilized in making network management decisions.

In additional embodiments, the process 600 can generate a report associated with the polygon (block 640). The report may be formatted in a manner that can be read by an AP. The report may be formatted as a single report, or may include time-series data, such as a time-window.

In certain optional embodiments, the process 600 can allocate the report (block 650). In various embodiments where multiple reports are generated, or reports include time-series data, the process 600 can allocate the report as needed. In more optional embodiments, the process 600 can transmit the report (block 660). In some embodiments, the report can be sent wirelessly to an AP which generated the query. However, certain embodiments, may transmit the report(s) to a centralized wireless AP or network device that is tasked with making network management decisions for a plurality of APs.

Although a specific embodiment for a generating a report based on a location within a path suitable for carrying out the various steps, processes, methods, and operations described herein is discussed with respect to FIG. 6, any of a variety of systems and/or processes may be utilized in accordance with embodiments of the disclosure. For example, the process 600 may operate within an AP, or may be a separate network device. In some embodiments, multiple AFCs may report to a single AP or vice-versa. The elements depicted in FIG. 6 may also be interchangeable with other elements of FIGS. 1-5 and 7-11 as required to realize a particularly desired embodiment.

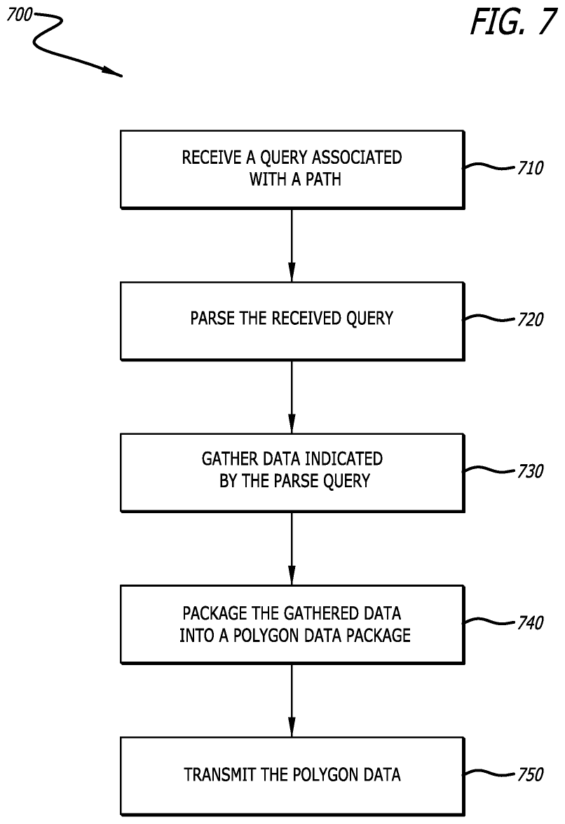

Referring to FIG. 7, a flowchart depicting a process 700 for processing polygon data in accordance with various embodiments of the disclosure is shown. In many embodiments, the process 700 can receive a query associated with a path (block 710). The query can be received from an AP that is travelling along or is otherwise associated with a path. However, the process 700 can be configured in certain embodiments to transmit polygon data at periodic intervals, without the need for a query request.

In a several embodiments, the process 700 can parse the received query (block 720). Parsing the query may include determining what data is being requested. This data may be associated with a certain location or polygon within the area. Additional embodiments may include queries that have estimated time of arrivals which may allow for prioritization of received queries.

In more embodiments, the process 700 can gather data indicated by the parsed query (block 730). The data requested may be accessed in a variety of ways. In some embodiments, the process 700 may access a database to retrieve the requested data. In certain embodiments, the process 700 may examine current telemetry data, or may reach out to other network devices regarding the requested data.

In further embodiments, the process 700 can package the gathered data into a polygon data package (block 740). The polygon data package can be a format that encompasses all of the requested data into one file. However, as those skilled in the art will recognize, the packaging of data can occur in a variety of ways.

In additional embodiments, the process 700 can transmit the polygon data (block 750). The polygon data can be sent to the network device that requested it. However, in some embodiments, the original query may indicate a different target destination that can receive the packaged polygon data.

Although a specific embodiment for processing polygon data suitable for carrying out the various steps, processes, methods, and operations described herein is discussed with respect to FIG. 7, any of a variety of systems and/or processes may be utilized in accordance with embodiments of the disclosure. For example, certain embodiments may have a predetermined polygon package that is broadcast, which may be processed first, and yield a smaller or amended query, thus reducing the overall time needed to process new queries. The elements depicted in FIG. 7 may also be interchangeable with other elements of FIGS. 1-6 and 8-11 as required to realize a particularly desired embodiment.

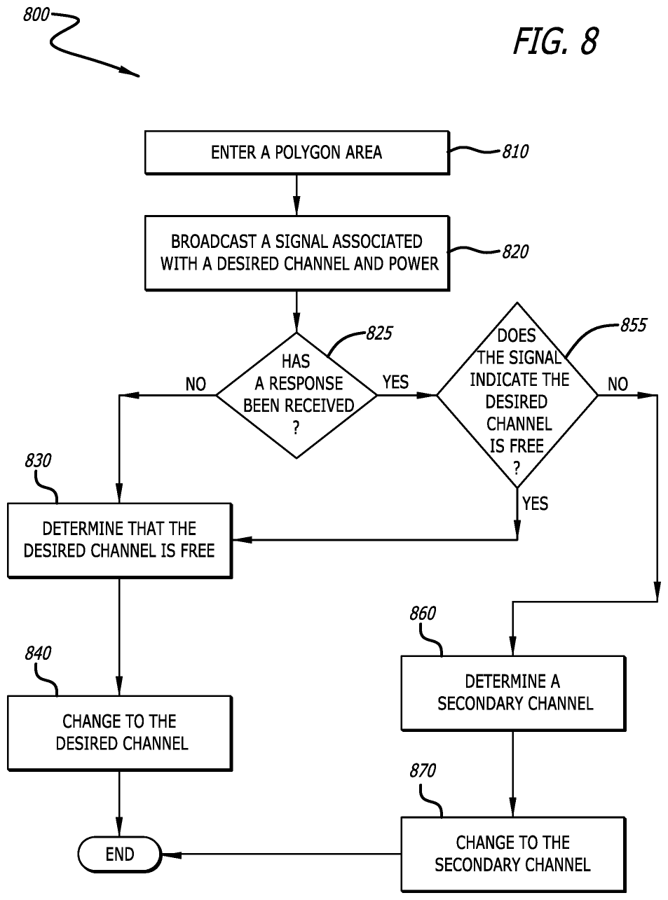

Referring to FIG. 8 is a flowchart depicting a process 800 for operating a sublet system based on a location within a path in accordance with various embodiments of the disclosure is shown. In many embodiments, the process 800 can enter a polygon area (block 810). As described above, a polygon area can be any area or location associated with a path, such as a track, etc. In certain embodiments, the process 800 may not need to enter a new polygon area, but instead wait for a change event.

In a number of embodiments, the process 800 can broadcast a signal associated with a desired channel and power (block 820). In some embodiments, the broadcast can be relayed to upcoming locations. The broadcast may also be varied based on the precision needed.

In various embodiments, the process 800 can determine if a response has been received (block 825). If no response has been received, then the process 800 may determine that the desired channel is free (block 830). However, if a response has been received, the process 800 can further determine if the signal indicates if the desired channel is free (block 855). If the indication is that the desired channel is free, then the process 800 can also determine that the channel is free (block 830). In some embodiments, when it is determined that the desired channel is free, the process 800 can change to the desired channel (block 840).

However, when the signal indicates that the desired channel is not free, then the process 800 can determine a secondary channel (block 860). A secondary channel can be another channel that may be within a common or useful channel selection, but is not the first choice. In various embodiments, the process 800 may pick a tertiary channel, quaternary channel, etc. until a useful channel is found. In additional embodiments, the process 800 can change to the secondary channel (block 870). This channel change is often done by the AP. The AP may change a channel in response to receiving a request to.

Although a specific embodiment for operating a sublet system based on a location within a path suitable for carrying out the various steps, processes, methods, and operations described herein is discussed with respect to FIG. 8, any of a variety of systems and/or processes may be utilized in accordance with embodiments of the disclosure. For example, the broadcast response can be received in response to a received broadcast, or may itself be broadcast out for any device to receive and parse. The elements depicted in FIG. 8 may also be interchangeable with other elements of FIGS. 1-7 and 9-11 as required to realize a particularly desired embodiment.

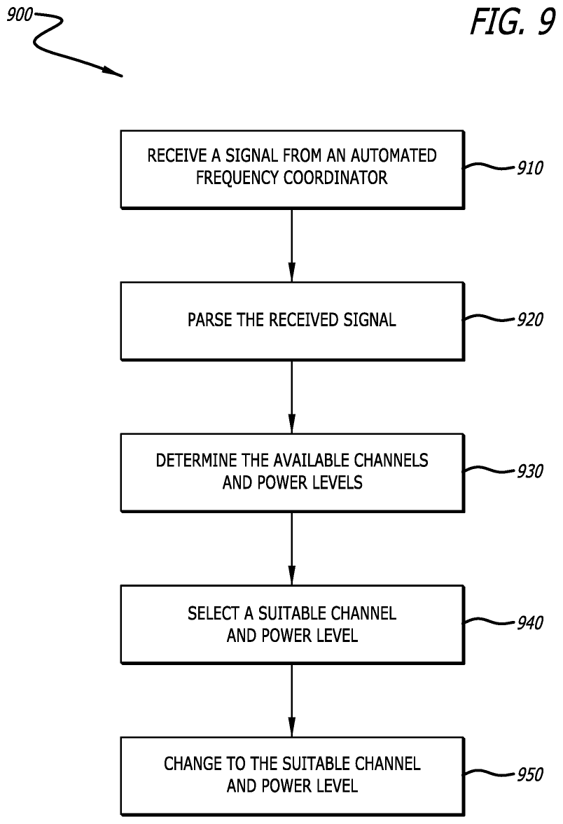

Referring to FIG. 9, a flowchart depicting a process 900 for operating an access point within a path in accordance with various embodiments of the disclosure is shown. In many embodiments, the process 900 can receive a signal from an automated frequency coordinator (block 910). As described above, various devices, such as APs associated with paths can rely on direction given by AFC devices to change channels and adjust other settings as needed.

In various embodiments, the process 900 can parse the received signal (block 920). The received signal may include a request for information related to a certain portion of a track or path. In some embodiments, the signal may be a request for a plurality of portions on a path, which may comprise a sub-path. However, the received signal may be an indication or request to either change channels/bandwidth or what channel/bandwidth options are available which can then be determined which to select.

In more embodiments, the process 900 can determine the available channels and power levels (block 930). As previously described, the process 900 may be given data related to channels/bandwidth. In various embodiments, the received signals can be utilized to understand what channels, bandwidth options, or other network attributes are available in the near future or currently. The process 900 can determine which data needs to be processed and what current channel or attribute decision needs to be made currently.

In additional embodiments, the process 900 can select a suitable channel and power level (block 940). Based on the available information, the process 900 can make a selection based on the current, or near-future events that may occur, such as, but not limited to, moving down a path. Depending on various conditions, such as speed, this selection can be made more or less often.

In further embodiments, the process 900 can change to the suitable channel and power level (block 950). In response to a selection being made, the channel, power, bandwidth, or other attribute can be changed. This chance can be directed to the local device or can be relayed to other network devices in the area.

Although a specific embodiment for operating an access point within a path suitable for carrying out the various steps, processes, methods, and operations described herein is discussed with respect to FIG. 9, any of a variety of systems and/or processes may be utilized in accordance with embodiments of the disclosure. For example, some embodiments may only make selections and change channels, while others will only change power. The elements depicted in FIG. 9 may also be interchangeable with other elements of FIGS. 1-8 and 10-11 as required to realize a particularly desired embodiment.

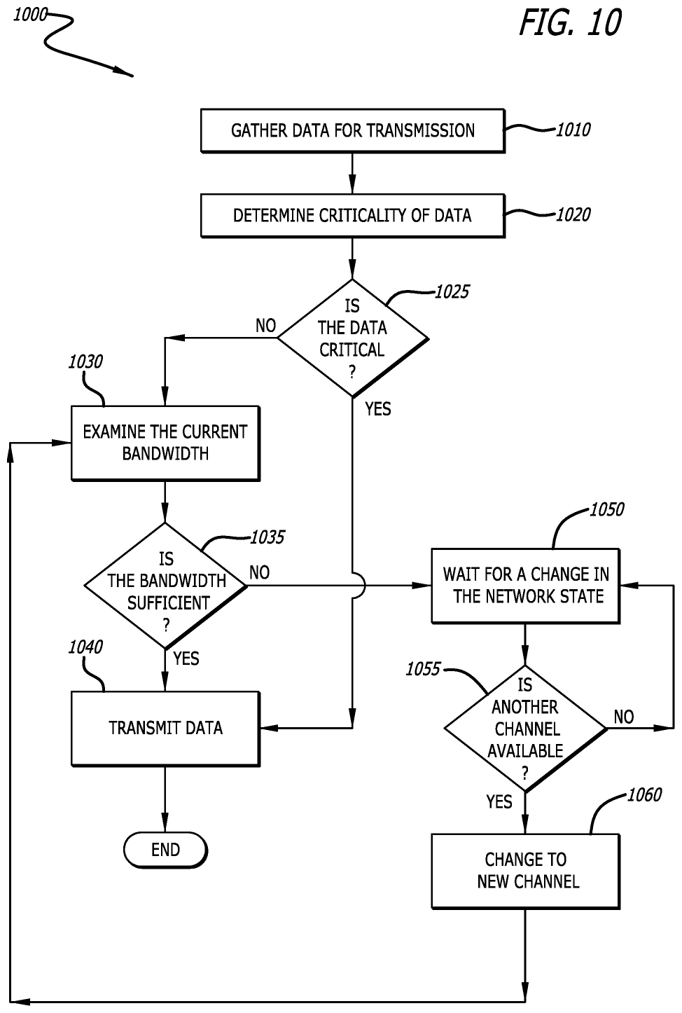

Referring to FIG. 10, a flowchart depicting a process 1000 for holding data when travelling on a path in accordance with various embodiments of the disclosure is shown. Network devices associated with vehicles operating on or otherwise associated with a path/track, such as trains or autonomous vehicles, can generate and transmit various types of operational data to ensure efficient and safe operations. The nature of this data can vary depending on the specific context and purpose of the vehicle. Telemetry data is often transmitted, providing real-time information about the network and/or vehicle's status. Additionally, positional data, obtained through GPS or other location tracking systems, may be continuously transmitted, facilitating route optimization, progress tracking, and adherence to designated areas. Further diagnostic information may be transmitted as well.

In many embodiments, the process 1000 can gather data for transmission (block 1010). As described above, this may include operational data. This data can be gathered by a single device from a plurality of other devices. However, certain embodiments may comprise each wireless device gathering their own data.

In a number of embodiments, the process 1000 can determine the criticality of the data (block 1020). Based on the type of data, how stale it is, or other factors, it may be deemed critical or non-critical. In some embodiments, the determination may have a plurality of different criticality levels, each with an associated bandwidth or power that it should be transmitted at.

In various embodiments, the process 1000 can determine if the data is critical (block 1025). If it is determined that the data is critical, the process 1000 can transmit the data (block 1040). However, if it is determined that the data is not critical, then the process 1000 can examine the current bandwidth (block 1030). This can be done via one or more measurements or examining other telemetry data.

In several embodiments, the process 1000 can determine if the bandwidth is sufficient (block 1035). The sufficiency can be a predetermined value or can be dynamically adjusted based on the current status of various network attributes or based on other telemetry data. In certain embodiments, this evaluation may take into account historical data associated with the current and upcoming locations on a path. If the bandwidth is determined to be sufficient, then some embodiments of the process 1000 may subsequently transmit the data (block 1040).

However, if the bandwidth is determined to be insufficient, then the process 1000 can wait for a change in the network state (block 1050). The waiting period may be a predetermined amount of time or may be dynamically selected based on various factors or other telemetry data. In some embodiments, a change event may occur that is noticed by, or otherwise affects the network, which may trigger subsequent actions. After some amount of time, the process 1000 can determine if another channel is available (block 1055). If no other channels are available, then the process 1000 can continue to wait for a change in the network state (block 1050).

However, if another channel is available, then the process 1000 can change to a new channel (block 1060). This new channel may have more available bandwidth. Therefore, the process 1000 may further again examine the current bandwidth (block 1030). This process may repeat itself until the data is able to be transmitted.

Although a specific embodiment for holding data when travelling on a path suitable for carrying out the various steps, processes, methods, and operations described herein is discussed with respect to FIG. 10, any of a variety of systems and/or processes may be utilized in accordance with embodiments of the disclosure. For example, the determination of criticality can be heuristically decided, or may be dynamically generated based on various factors, which can include one or more machine-learning processes. The elements depicted in FIG. 10 may also be interchangeable with other elements of FIGS. 1-9 and 11 as required to realize a particularly desired embodiment.

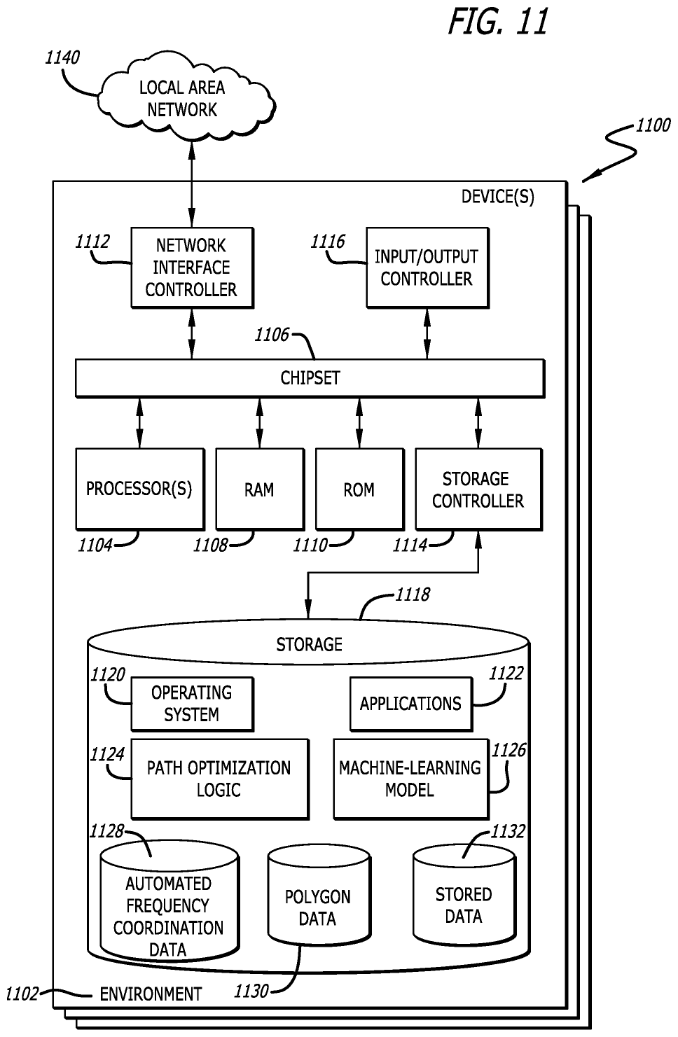

FIG. 11 is a conceptual block diagram of a device 1100 suitable for configuration with a path optimization logic, in accordance with various embodiments of the disclosure. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, applications 1122, automated frequency coordination data 1128, polygon data 1130, and stored data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 918 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include a path optimization logic 1124. The path optimization logic 1124 can be configured to perform one or more of the various steps, processes, operations, and/or other methods that are described above. Often, the path optimization logic 1124 can be a set of instructions stored within a non-volatile memory that, when executed by the processor(s)/controller(s) 1104 can carry out these steps, etc. In some embodiments, the path optimization logic 1124 may be a client application that resides on a network-connected device, such as, but not limited to, a server, switch, personal or mobile computing device in a single or distributed arrangement. In certain embodiments, the path optimization logic 1124 can be a part of an AFC device. In further embodiments, the path optimization logic 1124 may be part of an AP device. In still more embodiments, the path optimization logic can be a part of a server or other wireless networking device that can provide various historical and/or polygon info to requesting devices. In more embodiments, the path optimization logic 1124 can also monitor and control the channel selection of one or more devices. In some more embodiments, the stored data 1132 may be held until a sufficient bandwidth is available. The polygon data 1130 can be associated with one or more polygons in a fixed path area. The automated frequency coordination (AFC) data 1128 can be utilized to coordinate and/or process AFC-related data during an AFC process.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126.

The ML model(s) 1126 can be configured to generate inferences to make predictions or draw conclusions from data. An inference can be considered the output of a process of applying a model to new data. This can occur by learning from at least the automated frequency coordination data 1128, the polygon data 1130, and the stored data 1132 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although a specific embodiment for a device 1100 configured with a path optimization logic suitable for carrying out the various steps, processes, methods, and operations described herein is discussed with respect to FIG. 11, any of a variety of systems and/or processes may be utilized in accordance with embodiments of the disclosure. For example, the device may be configured as an AFC device, an AP, or other network device that responds to, or is in communication with an AFC, AP or like device. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device comprising:
a processor;
a memory commutatively coupled to the processor;
at least one network interface controller configured to provide access to a network; and
a path optimization logic configured to:
query an access point, wherein the query is associated with a path;
receive polygon data;
parse the polygon data; and
generate a report associated with the parsed polygon data.

2. The device of claim 1, wherein the path optimization logic is further configured to transmit the report.

3. The device of claim 1, wherein the query comprises a request for one or more polygons.

4. The device of claim 1, wherein the query comprises a request for two or more polygons associated with different altitude levels.

5. The device of claim 1, wherein the path optimization logic is further configured to:
generate two or more reports; and
aggregate the two or more reports.

6. The device of claim 1, wherein the path is configured with limited orthogonal movement.

7. The device of claim 6, wherein the path is a track.

8. The device of claim 7, wherein the device is in movement along the track.

9. The device of claim 8, wherein the path optimization logic is further configured to generate a query in response to one or more change events occurring.

10. The device of claim 9, wherein the one or more change events is a change in speed of movement along the track.

11. The device of claim 9, wherein the one or more change events is a variation in the path.

12. The device of claim 1, wherein the polygon data includes at least channel data.

13. The device of claim 1, wherein the polygon data includes at least power usage data.

14. A device comprising:
a processor;
a memory commutatively coupled to the processor;
at least one network interface controller configured to provide access to a network; and
a path optimization logic configured to:
receive a query, wherein the query is associated with a path;
parse the query for requested data;
gather the requested data;
package the requested data as polygon data; and
transmit the polygon data.

15. The device of claim 14, wherein the query is associated with a plurality of sections of the path.

16. The device of claim 15, wherein the plurality of sections of the path form a sub-path.

17. The device of claim 14, wherein parsing the query comprises determining a desired level of precision.

18. The device of claim 14, wherein the query includes an estimated time of arrival to a section of the path.

19. A method, comprising:
operating an access point on a path;
receiving automated frequency coordination data;
parsing the automated frequency coordination data;
determining a channel and bandwidth based on the automated frequency coordination data; and
configuring the access point to change to the determined channel and bandwidth.

20. The method of claim 19, wherein the determination comprises a constrained optimization decision.
